(19) United States
(12) Patent Application Publication
(10) Pub. No.: US 2004/0051392 A1
(43) Pub. Date: Mar. 18, 2004

(54) Operating device

(76) Inventor: Ziad Badarneh, Oslo (NO)

Correspondence Address: RODMAN RODMAN, 7 SOUTH BROADWAY, WHITE PLAINS, NY, 10601

(21) Appl. No.: 10/380,971

(22) PCT Filed: Sep. 21, 2001
(86) PCT No.: PCT/NO01/00388

(30) Foreign Application Priority Data
Sep. 22, 2000 (NO) 20004771

(51) Int. Cl. H01H 1/00

(52) U.S. Cl. 307/112

(57) ABSTRACT

An operating device, where the device is actuatable by the fingers of a hand and is designed for control of functions in a functional apparatus that is equipped with a display screen or that communicates with a remote display screen. The operating device has a control element and a mounting ring designed for placing on a finger and designed for manipulation of said control element by using another finger on the same hand.

The present invention relates to an operating device wherein the device is actuatable by the fingers of a hand and is intended for control of functions in a functional apparatus that is equipped with a display screen or that communicates with a remote display screen.

It is previously known, for function control of a computer, to use a so-called mouse in connection with a pointer or cursor which can be controlled on the display screen and activate new functions, close programs, be of assistance in making adjustments etc. An operating device of this kind, is either connected to the computer via a cable or connected wirelessly to the computer. The use of such mouse devices often causes carpal tunnel syndrome which is due to uncomfortable straining of the wrist and which may also give rise to other muscular problems in the arms and shoulders. In addition, the use of such a mouse requires the hand operating the mouse to move constantly between the ordinary keyboard and the mouse, which not only reduces efficiency in handling the computer, but is also disruptive in an operation where most of the time the hand-is at the keyboard.

In other relations operating devices are known which must be held in the user's hand and where fingers on one of the user's hands operate the numerous function keys on the device.

It is thus an objective of the present invention to provide a multifunctional operating device which can be used both as a control means and a navigation means in connection with a functional apparatus that is equipped with a display screen or that communicates with a remote display screen.

According to the invention the device in a first embodiment is characterised in that the operating device has a control element and a mounting ring designed for placing on a finger and designed for manipulation of said control element by using another finger on the same hand.

In a second embodiment, where the operating device is intended for use in a vehicle, it is characterised in that it has a control element and a mounting ring designed to be placed on the steering wheel body or operating lever of a vehicle, where the control element is designed for manipulation using a finger on the hand that is holding the steering wheel or the lever.

Other embodiments of the said operating device will be apparent from the attached patent claims, and from the following description with reference to the attached drawings.

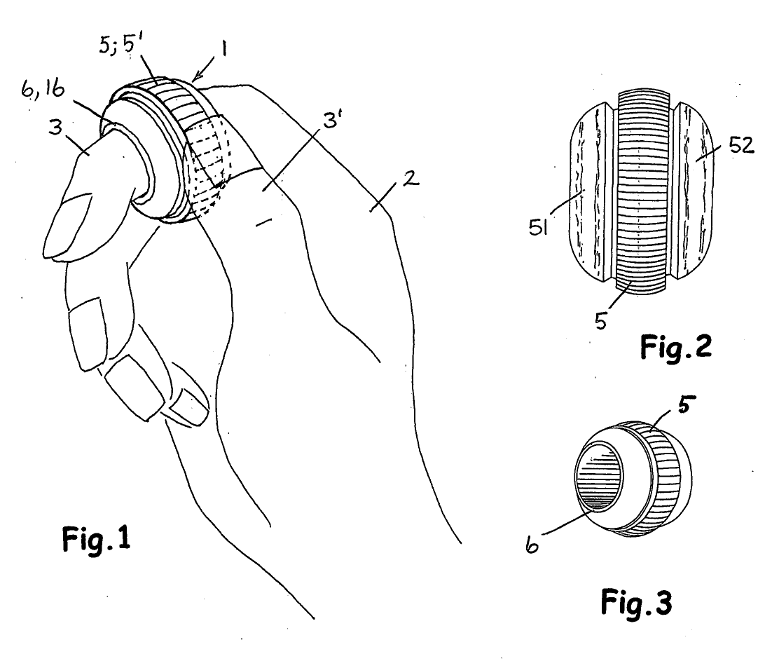

FIGS. 1-3 show one embodiment of the operating device used in connection with a hand, in an end view and in a perspective view respectively.

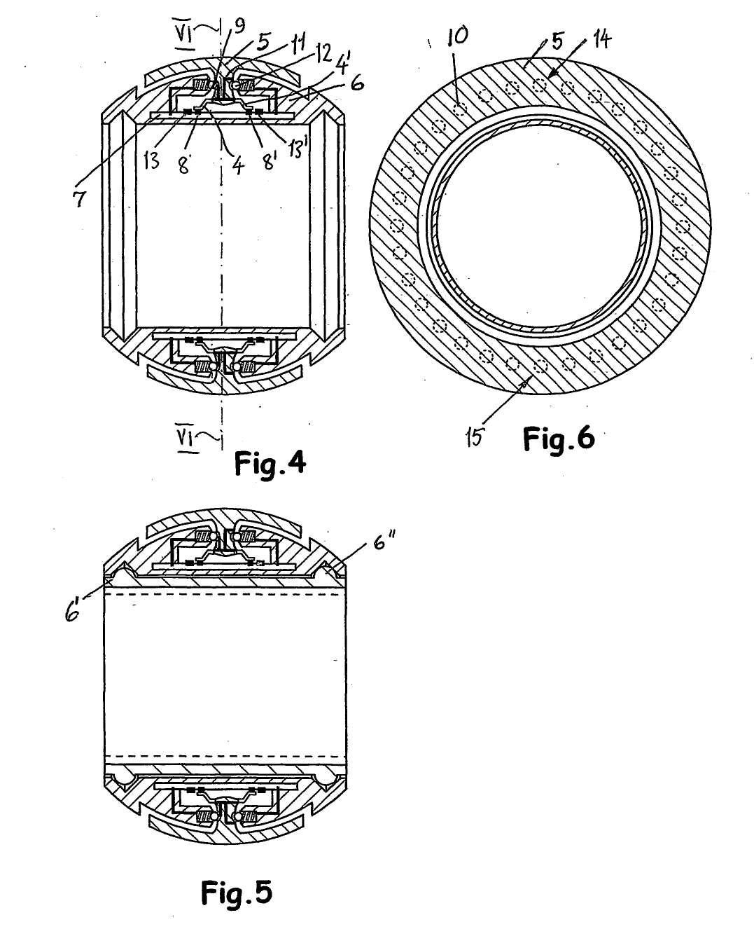

FIG. 4 shows a longitudinal cross-section through the operating device according to the invention.

FIG. 5 shows the same as FIG. 4, but with an: inserted ring lining..

FIG. 6 is a sectional view taken along the line VI-VI in FIG. 4.

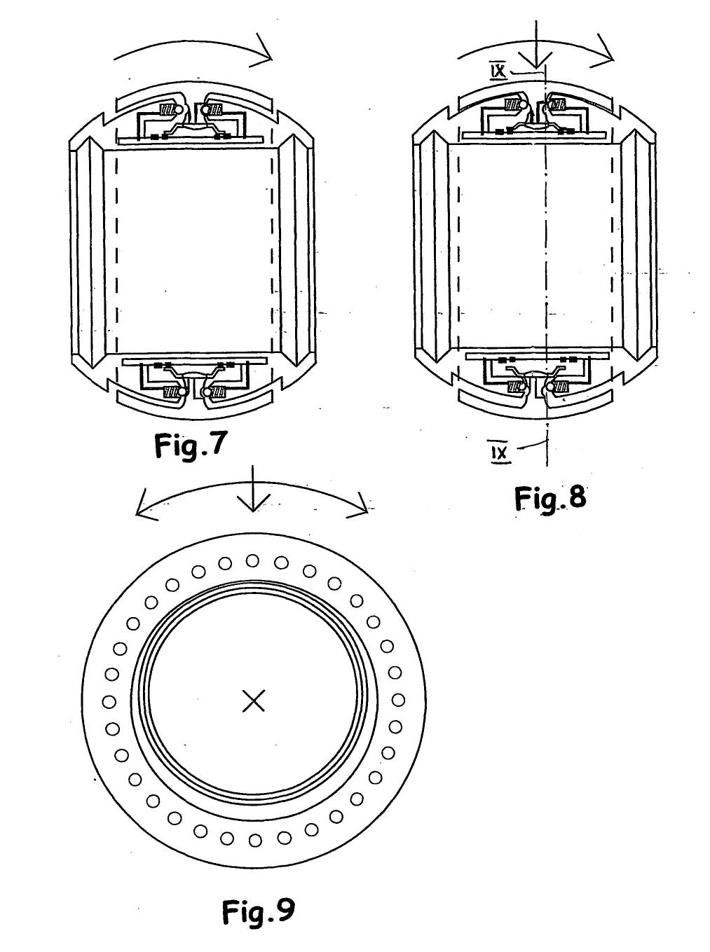

FIGS. 7 and 8 show the device in FIGS. 4 and 5 where FIG. 7 shows a portion of the control element pushed towards one side and where FIG. 8 shows the control element depressed at the same time.

FIG. 9 is a sectional view taken along the line IX-IX in FIG. 8.

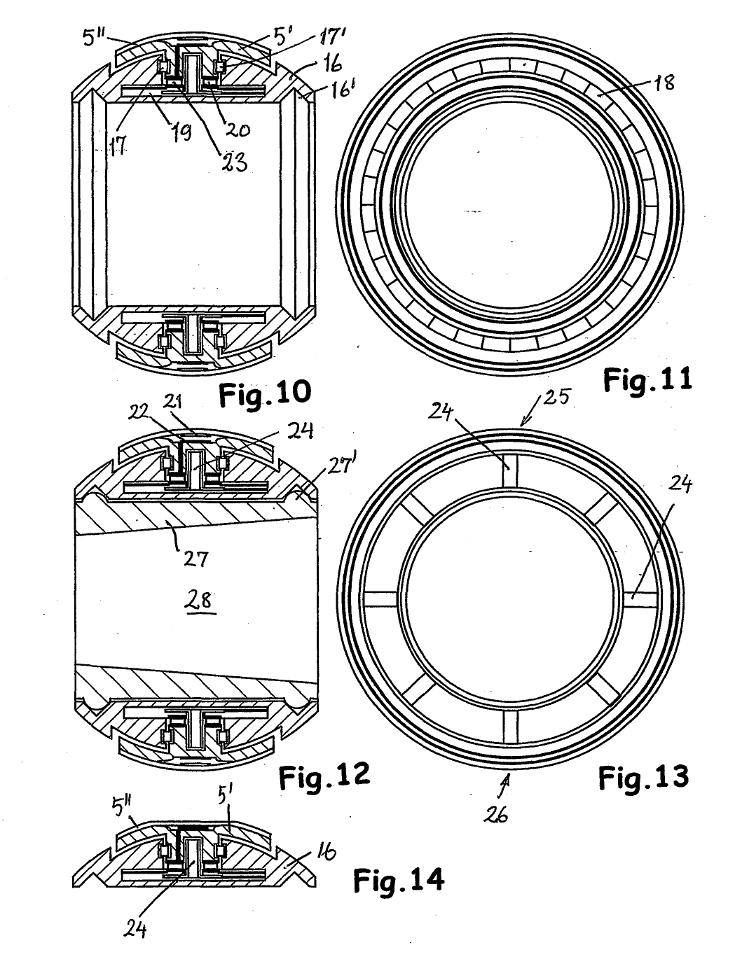

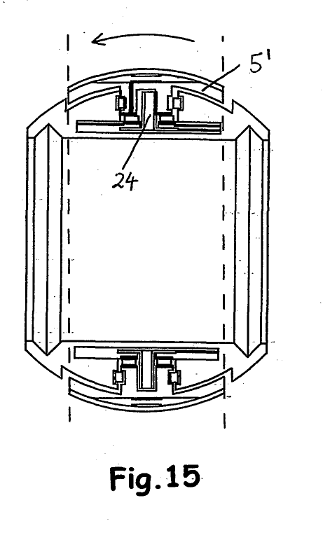

FIGS. 10-15 show a variant of the device shown in FIGS. 4-9, where FIG. 10 is a sectional view taken along the line X-X in FIG. 11, FIG. 11 is a sectional view taken along the line XI-XI in FIG. 10, FIG. 12 is a sectional view taken along the line XII-XII in FIG. 13, FIG. 13 is a sectional view taken along the line XIIII-XII in FIG. 12, FIG. 14 shows a detail in connection with the depression of the control element on the operating device, and FIG. 15 shows a tilting movement of the control element on the operating device.

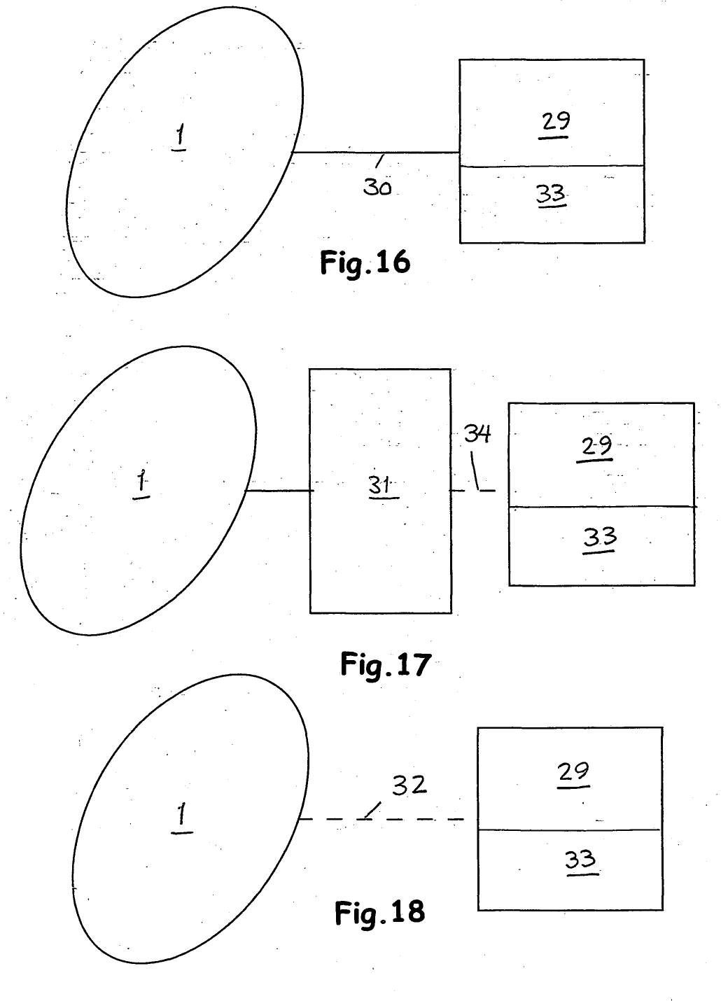

FIGS. 16-18 shows alternative solutions for communication between the operating device and functional equipment, for example a PC with display screen.

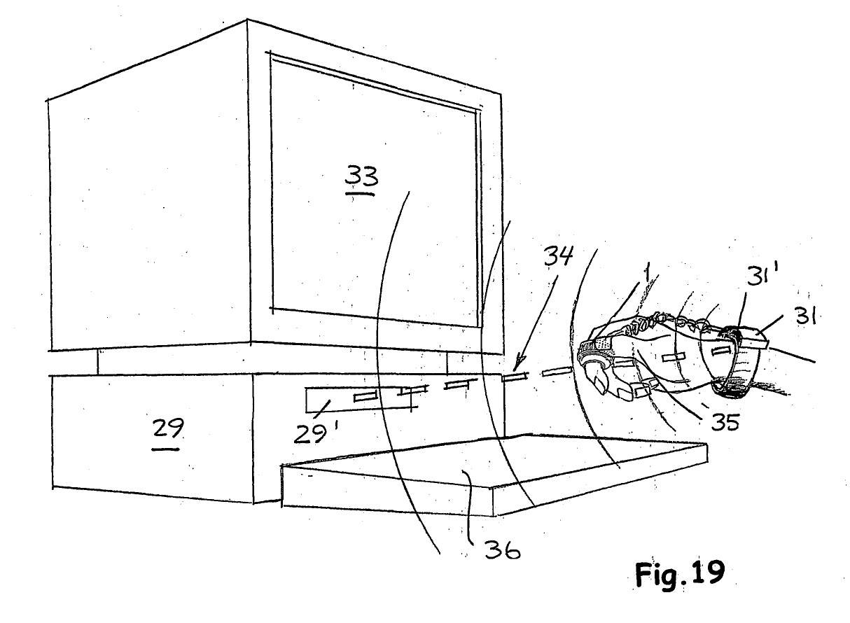

FIG. 19 shows by way of example a wireless connection between the present operating device and a functional apparatus such as a computer (PC) having a display screen.

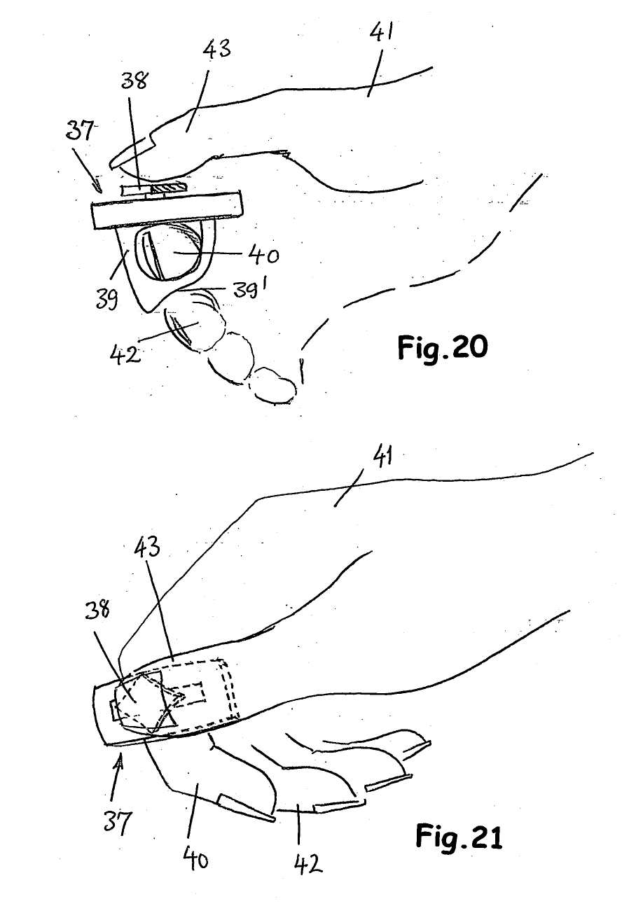

FIGS. 20, 21 and 22 show an alternative embodiment of an operating device, where FIGS. 20 and 21 show the device in connection with a user's hand.

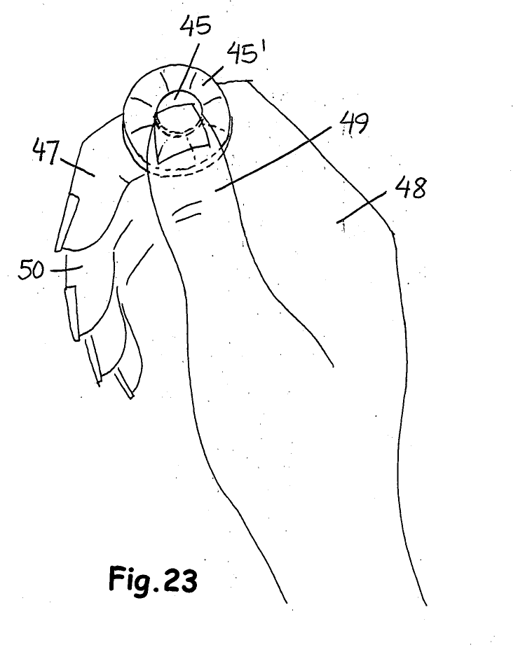

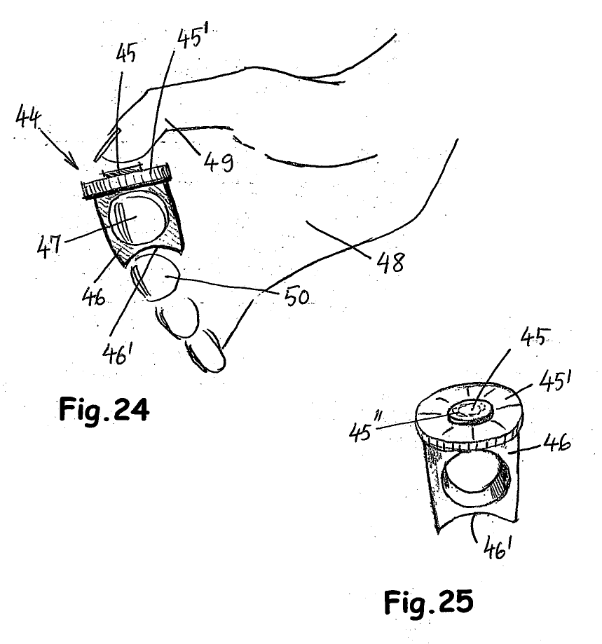

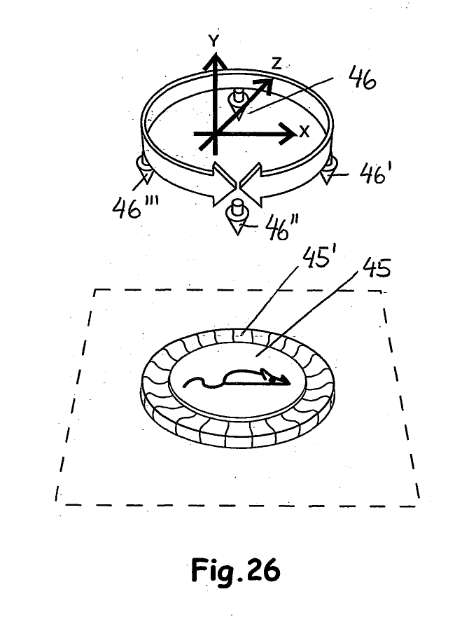

FIGS. 23, 24, 25 and 26 show another alternative embodiment of the device according to the invention, where FIGS. 23 and 24 show the device when it is held and operated by a hand, FIG. 25 shows the device in perspective, and FIG. 26 shows the operating principle of the device.

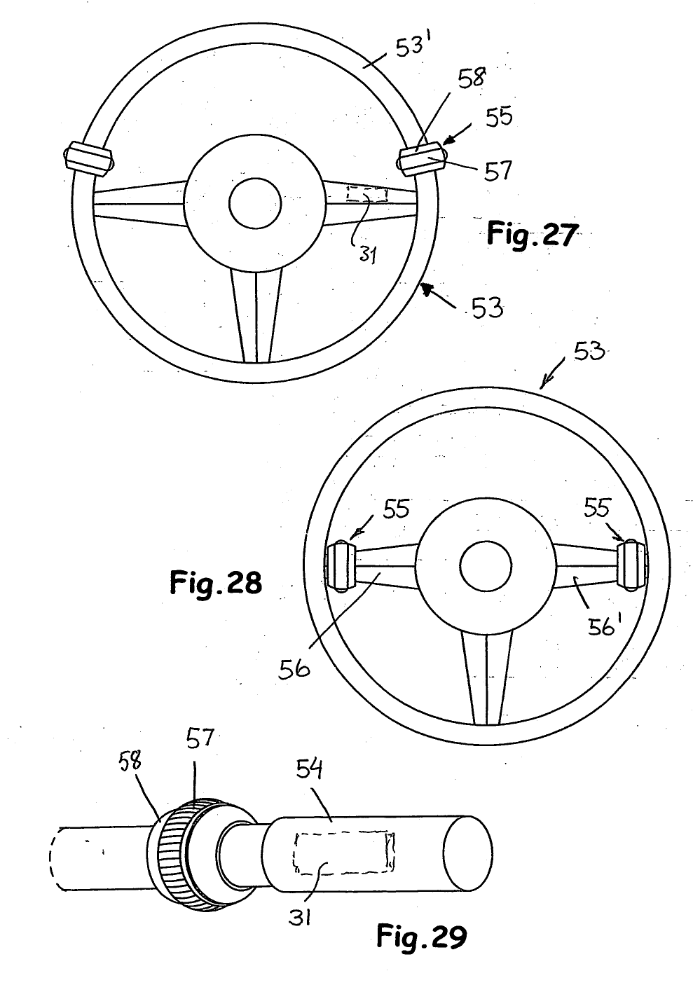

FIG. 27 shows the device according to the present invention used in connection with the steering wheel ring body of a vehicle.

FIG. 28 shows the device according to the present invention used in connection with cross arms on a vehicle steering wheel.

FIG. 29 shows the operating device in connection with a vehicle operating lever or handle, as for instance a steering column handle, gear lever, handlebars or the like.

FIGS. 1-3 show an operating device, where the device 1 is actuatable by the fingers of a hand 2, where the operating device can be worn on a finger 3, for example, an index. finger, and operated by the thumb 3′ of the hand. The operating device has a control element 5 and a mounting ring 6 which enables the operating device to be placed on the finger 3. The size of the operating device will inevitably depend upon how much electronics it is desirable to implement. In an embodiment for use with, for example, a stationary computer, permanent wiring would be permissible, but as is well-known wireless connections between a mouse, for instance, and a computer are already widely used today. Wireless technology for small apparatuses is progressing at a furious pace, and it is first and foremost “blue tooth” technology that could be an alternative for communication between the operating device and the apparatus to be controlled.

FIGS. 4-9 show a first embodiment of the operating device in more detail. The control element 5 is designed to be capable of rotating in both directions about the ring member 6 which at the same time forms a mounting ring for the operating device. The control element 5 can be tilted or depressed to each side, and also pressed in towards the centre of the control element. Tilting and depression can take place around the entire switch part. Between the ring member 6 and the control element 5 there is a circuit board 7 which contains paths of current for the purpose of being able to detect both rotation of the control element 5 and tilting and/or depression of the same. The control element 5 has contact projections 4, 4′ which in a normal position and on rotation are in contact with contact paths 8, 8′. Spring-loaded contact 9 detects rotation of the control element 5 in that one of the current paths on the control element 5 is broken between the positions 10 on the ring member 6, as indicated in both FIG. 4 and FIG. 6.

As will be understood from FIG. 4, the ball 9 is current-carrying. On direct depression of the control element 5, as outlined in FIG. 8, the contact connection 11 will form electrical contact with the current-carrying, spring-loaded ball 12. It will be appreciated that the stepwise movements of the control element 5 can take place in this case with the aid of the spring-loaded balls 9, 12 which will engage with the stepwise recesses 10 in a central part of the control element 5. The stepwise movements of the control element 5 will of course easily be detected by means of suitable registering-equipment (not shown) that is known per se when the operating device is manipulated whilst the user views a functional apparatus provided with a display screen. As mentioned above, the functional apparatus can be equipped with a display screen or communicate with a remote display screen.

Tilting the control element S to the side will result in the projections 4, 4′ contacting one or the other of the current paths 13, 13′. This can be seen clearly from FIG. 7. It is also possible in this position to depress the control element 5 for optional confirmation of a selected function, and this is shown in more detail in FIG. 8. If the control element 5 is in the centre position, as shown in FIGS. 4 and 5, and is depressed in this centre position, the contact connection 11 will form electrical contact with the contact ball 12, whilst the contact projections 4, 4′ are brought into contact with both contact paths 8, 13 and 8′ 13′. All tilting movement of the control element 5 will have a pivot point approximately 180° from the point of actuation. When actuation takes place at point 14, the pivot point will in reality be 180° therefrom at the point indicated by the arrow 15.

Adaptation of the mounting ring or ring member 6 can be effected by using replaceable linings 6′, as shown in FIG. 5, where the lining has pins 6″ which fit into corresponding cut-outs in the member 6.

FIGS. 10-15 are related to an alternative embodiment of the operating device as shown in preceding FIGS. 4-9.

In this case, there is a control element 5′ that is designed to be capable of rotating in both directions about a mounting ring 16. The control element 5′ is designed to rotate between springs 17, 17′, and these springs are fixed in the ring or ring member 16. Provided in the control element 5′ are stepwise grooves 18 in which the springs run. The number of steps can vary and should by no means be understood as defining the limits of the invention. The steps 18 can be detected by means of contact points in a circuit board 19 which is fitted in the ring body 16 and where contact can be established via spring 20. The control element 5′ has a top part 5″ of a material that is capable of being slightly yielding or of springing and which in its centre around the whole of the periphery of the control element can be pressed towards the centre, as indicated in FIG. 14. In this way contact between contact points 21 and 22 (see FIG. 12) is formed. The spring force provided by the top part 5″ will-be such that it is not yielding on normal rotation of the control element 5′ or on sideways tilting thereof, but will require a distinct pressure towards its centre to be yielding and thus establish contact between the points 21 and 22. On contact between the points or elements 21′ and 22′; a signal of this contact will be given via a path that is in contact with the control element 5′ via a spring 23. Tilting movements can be detected by strain gauge-equipped bars 24, where the strain gauges are connected to the circuit board 19. Such strain gauge bars 24 will be very sensitive, the slightest sideways movement being readily detected. Detection will inevitably be most effective closest to the point of contact, as indicated by the reference numeral 25 in FIG. 13, and will only have a small effect at a point offset by 180° from the point 25, as indicated by the arrow 26. The strain gauge-equipped bars 24 will-be located on the circuit board which extends around the whole circumference of the ring body 16 and spaced at certain intervals, for example, intervals of 60°.

As in FIG. 5, the ring member 16 in this case is also provided with a lining 27 which optionally may have a gradually tapering through opening 28. The replaceable lining 27 has small projections 27′ for engagement with corresponding recesses 16′ on the ring body 16.

In FIG. 15 it is shown how the strain gauge bars 24 are actuated when the control element 5′ is tilted sideways, as indicated by the arrow in FIG. 15, whereby the strain gauge bar 24, as shown, is subjected to strain, especially from one side, whereby a measuring imbalance is produced in, for example, a measuring bridge (not shown).

As shown in FIG. 16, it is conceivable that the operating device can be connected to a functional apparatus 29 via wiring 30. As can be seen from FIG. 17, it is also conceivable that associated with the operating device 1 there is connected a signal processing unit 31 which, for example, may contain a microprocessor, power supply and signal transmitter, for example, for optical, radio wave-based or other wireless communication with the functional apparatus 29. Furthermore, as shown in FIG. 18, it is conceivable that the operating device 1 can have integrated therein, for example, such microprocessor, power supply and means for wireless signal transmission 32, so as to allow satisfactory communication between the operating device and the functional apparatus 29 to take place. The functional apparatus 29 may optionally be a computer or, per se, any other functional apparatus.

A functional apparatus of this kind will inevitably also have a display screen, as indicated by the reference numeral 33. In connection with the illustrated embodiments of the operating device, the implementation of hardware such as microprocessor, power supply and signal transmitter integrated in the actual operating device is not shown. Initially, it is desirable to make the operating device, as for instance the embodiment shown in FIGS. 14 and also FIGS. 4-9 and FIGS. 10-15, as small as possible. However, it will generally be understood that the integration of, for example, equipment as represented by the reference numeral 31 in the actual operating device could entail such an increases in the size of the device that it will not be convenient to wear it on a finger. However, technological advance is rapid and miniaturisation will permit such a solution in a few years. Although the functional apparatus 29 may be a personal computer it is, of course, conceivable that the functional apparatus per se may be any electronic apparatus, as for instance a mobile telephone, PDA, equipment for in-car control of applications such as a telephone, radio etc which has accompanying display on a display 33 on the vehicle dashboard.

In the solution shown in FIG. 12, the member or unit 31, which as mentioned contains a microprocessor, power supply and signal transmitter, may optionally be placed on the user's wrist, as shown in FIG. 13. The wireless connection between the unit 31 and the functional apparatus 29 with its display screen 33 is indicated by the reference numeral 34. This wireless connection may take place via blue tooth technology, optical connection, for example, laser, or other wireless technology, where the unit 31 may have a transmitter 31′ and where a signal receiver 29′ is provided on the functional unit 29.

A major advantage with the solution shown in FIG. 19 is that the user will at all times have the operating device at his disposal without having to move his hand 35 away from, for example, a keyboard 36, to reach a mouse in order to carry out “pointing tasks” on the computer display screen 33.

It is also conceivable that the operating device 1 will be ideal for controlling, for example, a mobile telephone, and perhaps in particular whilst driving a car.

Although the embodiments shown and described in connection with preceding FIGS. 1-15 and applications thereof as shown in FIGS. 16-19 are at present preferred, it is of course possible to use alternative embodiments of operating devices, and a couple of typical examples of these will now be described in more detail.

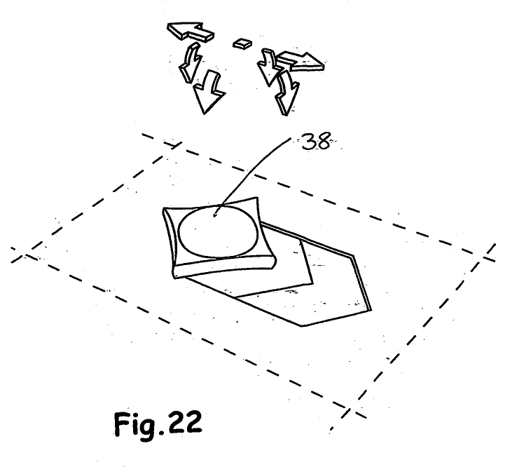

The operating device shown in FIGS. 20 and 21 and in rather more functional detail in FIG. 22 is indicated in general by the reference numeral 37. It has a control element 38 which is made in the form of a stepwise movable sliding key having a tilting and/or depression function so as to actuate switches in the operating device. In addition, the operating device has a mounting ring 39 which can be placed on a finger 40 on the user's hand 41. Advantageously, the ring and thus the operating device 37 is worn on the user's index finger, whilst the ring may have an indentation 39′ which can rest against the user's middle finger 42 so as to be positioned in a rather more stable manner. The last-mentioned is especially important if the control element is to be moved backwards and forwards by the thumb 43 of the hand. Connections to functional equipment, as represented by the reference numerals 29 and 33 in FIGS. 16, 17 and 18, could take place in the same way as shown and described in connection with these figures and do not require any further explanation. It will thus be understood that communication with such functional equipment can take place via wiring or via wireless communication.

The basic functions of the operating device are further illustrated in FIG. 22 where it will be seen that the control element 38, in a preferred embodiment, but an embodiment that is by no means limiting for the present invention, can be equipped with tilting functions, so that the control element in the form of the sliding key 38 can be tilted forwards or backwards or to both sides. Such tilting movements can be made in each individual one of the possible stepwise positions of the sliding key 38. It is also conceivable that the sliding key in the individual positions can be depressed centrally to activate specific functions. Thus, in reality there is in each stepwise position the possibility of using the operating device to choose between a total of five options.

The embodiment shown in FIGS. 23-25 shows an operating device 44 which like the previous operating device has control element part 45, 45′ and a mounting ring or ring body 46 which is preferably worn on the user's index finger 47 and where the hand's 48 thumb 49 is in a position to actuate the control element part 45, 45′.

Expediently the said ring 46 has an indentation 46′ so that the ring can more easily rest against the user's middle finger 50. Thus, in reality the operating device is held stable by two fingers whilst it is manipulated by the user's thumb 49.

A solution as shown in FIGS. 23-25 would be particularly suitable for two-dimensional. or three-dimensional based control of a cursor on a display screen. The control element part 45, 45′ thus consists of a non-rotatable key 45 which has a centre position deviation function, i.e.; that the sideways movements of the key in any direction relative to its normal centre position is detectable and could control a typical cursor on a display screen, for example, to mark and selections or carry out functions or other operations by means of cursor control on a display screen. In FIG. 26 a function of this kind is indicated by the arrows x, y, and optionally with the addition of z, provided movement in several planes is involved. However, depending on x and y values, coordinates will be provided for control of a cursor on a display screen, such as the screen 33 in FIGS. 16-19.

The non-rotatable key 45 in the illustrated example is surrounded by a stepwise rotatable ring member 45′ which has depression functions at fixed points, as for instance the points indicated by conical arrows 46, 46′, 46″ and 46′″. Because the rotation of the ring member 45′ is detectable, it will be possible to move through menu alternatives, program alternatives etc. and to use at given options depression at points 46, 46′, 46″ or 46′″ to select a desired function. It will immediately be understood that the said depression points 46-46′″ are connected to switch functions located under the rotatable ring member 45′. The non-rotatable key 45 which has a centre position deviation function, may be equipped with a strain gauge-based deviation detector, although other such deviation detectors are of course possible.

Although a total of four alternatives of the operating device have been illustrated and described, it is also conceivable that on the contact face of the control element there is, in addition, a capacitance sensor. A capacitance sensor of this kind is, for example, indicated in FIG. 25 by the reference numeral 45′.

Other non-illustrated solutions may, for example, comprise a rotatable wheel or roller having keys located either side thereof. With reference to, for example, FIG. 2, it could be envisaged that the control element 5 was only rotatable in both directions and depressible, and that side portions of the mounting ring could be provided with keys 51, 52 designed as pressure switches or optionally as switches or as capacitance change sensors.

As an alternative to the operating device shown in FIGS. 20-22,. this could optionally be replaced by a linearly movable key having keys (not shown) located on either side, or be made in the form of a tilt switch or sliding switch, optionally with keys located on either side. A linearly movable switch, tilt switch or sliding switch of this kind could optionally have a centre position deviation function.

In its simplest form, the control element could consist of a tiltable switch in order to control the x/y or x/y/z function of a cursor on a display screen, where the z function could initiate choices of, for example, an icon which has the correct x/y coordinates.

In a possible variant of the present invention, the operating device with its mounting ring can, for example, be mounted on the steering wheel body 53 of a vehicle or on a vehicle operating lever 54. In FIG. 27 the operating device is indicated by the reference numeral 55 and is mounted on the ring body 53′ of the steering wheel. In FIG. 28 the operating device is mounted on the spokes or cross pieces 56, 56′ of the steering wheel. In addition, these operating devices can, in the illustrated exemplary embodiment, have a design as shown and described in connection with FIGS. 1-15. Thus, in this case there is a rotatable wheel or roller 57 which is rotatable about an operating device mounting ring 58 and where in addition to sideways tiltability there is also depressibility for activating a function after selection thereof.

It will immediately be understood that the mounting ring 58 as shown in FIGS. 27-29 will either be directly adapted to the parts of the steering wheel or lever on which it is to be placed or be provided with appropriate ring linings for adaptation to a desired cross-sectional dimension or cross-section. Signal transmissions to a functional apparatus, for example, for control of certain functions of a vehicle, could take place in the same way as shown and described in connection with, for example, FIGS. 16-18. In the embodiment shown in FIG. 16 can, for example, the reference numeral 29 denote functional equipment on the vehicle dashboard or other operating controls, optionally music centres or the like, whilst the reference numeral 33 can denote a large or small display screen expediently positioned relative to the driver's or passenger's field of view. The wiring that is indicated by the reference numeral 30 may optionally be provided in a traditional manner via slip-rings and contact connections through the steering column. It is also possible to use the solution outlined in FIG. 17, for example, by mounting a unit 31 for wireless connection with the functional equipment. A similar solution is also outlined in connection with FIG. 29.

However, the size of the operating device as shown in FIGS. 27, 28 and 29 is not necessarily so critical as when it is to be placed on a user's finger. The size can therefore be increased somewhat so that, for example, the systems engineering outlined in connection with FIG. 18 could be used.

Although FIGS. 1-15, FIG. 19 and FIGS. 20, 21 and 24, 25 in particular show different types of mounting rings, it will be understood that the design of these can be varied so that they can optionally be made of an elastically yielding material, a bendable material; specially designed strap fasteners etc. The essential principle is that the operating is device is intended for placing on a finger and intended for manipulation of the operating device control element by using another finger on the same hand.

1. An operating device which is operable by one finger of a user hand and is designed for control of functions in a functional apparatus that is equipped with a display screen or that communicates with a remote display screen, the operating device having a ring body and a control element, said control element formed as rotatable wheel or roller body rotatably mounted about a circumference region of the ring body, wherein said control element is stepwise movable about said ring body, and wherein said control element is sideways tiltable and/or depressible at any detectable step position thereof relative to the ring body, thereby enabling operation of a respective switch related function.

2. An operating device which is operable by one finger of a user hand and is designed for control of functions in a functional apparatus that is equipped with a display screen or that communicates with a remote display screen, the operating device having a ring body and a control element, said control element formed as rotatable wheel or roller body rotatably mounted about a circumference region of the ring body,
wherein the control element is stepwise movable about the ring body,
wherein a pair of side-switches is located on either side of the control element, and
wherein said control element is depressible at any detectable step position thereof relative to the ring body, thereby enabling operation of a respective switch related function, or one or the other of said side switches operable at any detectable step position of the control element.

3. An operating device according to claim 1, wherein said ring body is dimensioned so as to be located on one finger on a hand of a device user, and wherein the device is so designed that manipulation of said control element through rotation, tilting or depression thereof is enabled by using another finger on said hand.

4. An operating device according to claim 2, wherein said ring body is dimensioned so as to be located on one finger on a hand of a device user, and wherein the device is so designed that manipulation of said control element through rotation or depression thereof or depression of one of said side switches is enabled by using another finger on said hand.

5. An operating device according to claim 3 or 4, wherein said ring body is dimensioned so as to fit onto a forward region of the forefinger on the hand, whereby said manipulation can be made by means of the thumb on the hand.

6. An operating device according to claim 1 or 2, wherein said ring body is dimensioned so as to be located on a steering wheel or operating lever of a vehicle, wherein the device is so designed that manipulation of said control element through rotation, tilting or depression thereof is enabled by using a finger on a user hand being closest to the control element.

7. An operating device according to anyone of claims 1-6,
wherein the stepwise movement is detectable using first spring-loaded contact means on the ring member enabling stepwise successive electrical contact with a contact member integral with the control element at contact positions on said contact member, and
wherein said contact member has slide contact means for slidable contact with first contact means on the ring member.

8. An operating device according to claim 1,wherein tilting movement of the control element causes additional electrical contact between said slide contact means and one of a pair of second contact means on the ring member adjacent said first contact means through sideways movement of the slide contact member.

9. An operating device according to claim 7 or 8, wherein depression movement of the control element is detectable using second spring-loaded contact means on the ring member enabling at any step electrical contact with the contact member integral with the control element at contact positions on said contact member, and
wherein said contact member uses said slide contact means for said slidable contact with said first contact means on the ring member.

10. An operating device according to anyone of claims 7-9, wherein the first contact means are electrical current conduction paths located on a circuit board, and wherein said first spring-loaded contact means is in electrical contact with the circuit board.

11. An operating device according to anyone of claims 7-10 , wherein the second contact means are electrical current conduction paths located on a circuit board adjacent said first contact means, and wherein said second spring-loaded contact means is in electrical contact with the circuit board.

12. An operating device according to anyone of claims 1-6,
wherein the stepwise movement is detectable using spring-loaded slidable contact means on the control element enabling stepwise successive electrical contact with a contact member on the ring member at respective contact positions on said contact member, said contact member being integral with a circuit board extending around a circumference region of the ring member.

13. An operating device according to claim 11, wherein the control element is linked to sets of strain gauge equipped bars connected to said circuit board, said bars located at spaced intervals on a circumference of the circuit board, and wherein tilting movement of the control element causes strain gauge reactions or measurement imbalance.

14. An operating device according to claim 7, 8, 12 or 13, wherein the control element circumferentially has a resiliently depressible region which provides a switch function upon depression movement of the control element thereat, thus making electrical contact between depression contact elements located in said region.

15. An operating device which is operable by one finger of a user hand and is designed for control of functions in a functional apparatus that is equipped with a display screen or that communicates with a remote display screen, the operating device having a ring body and a control element, said ring body being dimensioned so as to be located on one finger on a hand of a device user, and the device being so designed that manipulation of said control element is made by using another finger on said hand,
wherein said control element is formed as a forward and backwards stepwise movable sliding key, said key at any stepwise position being selectively operable through action elected from: central depression, forward tilting, backwards tilting and sideways titling, to cause a respective switch function.

16. An operating device which is actuatable by one finger of a user hand and is designed for control of functions in a functional apparatus that is equipped with a display screen or that communicates with a remote display screen, the operating device having a ring body and a control element, said ring body being dimensioned so as to be located on one finger on a hand of a device user, and the device being so designed that manipulation of said control element is made by using another finger on said hand,
wherein said control element is formed as a stepwise rotatable ring member being depressible at specific points thereat to cause a respective switch function, said ring member surrounding a non-rotatable key which has deviation sensing means for sensing displacement away from its centre position.

17. An operating device according to one or more of claims 1-16, wherein a capacitance sensor is located on the contact face of the control element;

18. An operating device according to anyone of claims 1-17, wherein the operating device is in wireless communication with the functional apparatus.

19. An operating device according to claim 15 or 16, wherein said ring body is dimensioned so as to fit onto a forward region of the forefinger on the hand, whereby said manipulation can be made by means of the thumb on the hand.
